(19) United States
(12) Patent Application Publication
(10) Pub. No.: US 2024/0303029 A1
(43) Pub. Date: Sep. 12, 2024

(54) Personalized Mini Message Recorder

(71) Applicant: Derek Burkhard, Johns Island, NC (US)

(72) Inventor: Derek Burkhard, Johns Island, NC (US)

(21) Appl. No.: 18/422,313

(22) Filed: Jan. 25, 2024

Related U.S. Application Data
(60) Provisional application No. 63/489,592, filed on Mar. 10, 2023.

(51) Int. Cl. G06F 3/16

(52) U.S. Cl. CPC G06F 3/162

(57) ABSTRACT

A personalized mini record player device designed to record custom audio messages or music creations for up to a predetermined duration. The device features a personalized pivotable lid with hidden barrel hinges for smooth opening and closing. A touch-based or engraved play button, a decorative sound knob and static stylus/arm are included to provide nostalgic charm. The device includes a sound module with a time limit and an internal memory for storing the recorded audio. A microprocessor manages audio processing and playback controls, ensuring clear sound quality. The recorded audio can be saved and played back at any time. The device can be used as a personalized gift for special occasions and/or for sharing special sentiments.

### CROSS-REFERENCE TO RELATED APPLICATION

The present application claims priority to, and the benefit of, U.S. Provisional Application No. 63/489,592, which was filed on Mar. 10, 2023 and is incorporated herein by reference in its entirety.

### FIELD OF THE INVENTION

The present invention relates generally to the field of audio gifting devices. More specifically, the present invention relates to a novel audio recording device configured like a miniature record player. The device allows users to record custom audio for up to a predetermined time duration such as 4-minutes that can be played back on actions such as push of a button or opening lid of the device. The device is customized and can be used as a gift with improved sentimental and memorable values compared to flowers, cards, and the like. Accordingly, the present disclosure makes specific reference thereto. Nonetheless, it is to be appreciated that aspects of the present invention are also equally applicable to others like applications, devices, and methods of manufacture.

### BACKGROUND

By way of background, individuals express their love for their family and friends by giving gifts on several occasions such as birthdays, anniversaries, holidays, and more. Giving gifts allows individuals to show their thoughtfulness and care, making the recipient feel valued and cherished. Gifts also help in strengthening the relationship between the individual and the recipient. Traditionally individuals are used to giving generic gifts such as flowers, cards, and other generic items such as perfumes and more. However, in recent times, personalized gifts have become increasingly popular.

Unlike generic items, personalized gifts are tailored to the recipient's preferences, interests, and characteristics. This customization shows that the giver has put time and effort into selecting something personal, which enhances the emotional connection between the giver and the receiver. However, curating and finding such thoughtful gifts can be a challenging and time-consuming task.

With the advent of e-commerce, many individuals opt to order gifts online, which can be conveniently delivered to their loved ones' doorsteps. This gifting method may lack the sentimentality and personal touch that individuals desire. Individuals desire an easy way of gifting more sentimental and memorable gifts to their friends and family.

Therefore, there exists a long felt need in the art for a personalized and customized gift for loved ones. There is also a long felt need in the art for a personalized gift that adds sentimental value and a personal touch to the gifting process. Additionally, there is a long felt need in the art for a gifting device that allows an individual to record a personalized message for a recipient. Moreover, there is a long felt need in the art for an audio recording device that can be given as a small gift to others for special occasions such as a birthday, holiday, or anniversary. Further, there is a long felt need in the art for a personalized and customized gift that can be configured like a miniature record player. Furthermore, there is a long felt need in the art for a mini record player gift device that allows recipients of the gift to listen to a recorded customized audio from a sender of the gift device. Finally, there is a long felt need in the art for a record player gift device that offers a much more sentimental and memorable gift compared to flowers, cards, and the like.

The subject matter disclosed and claimed herein, in one embodiment thereof, comprises a personalized mini record player device designed as an audio recording device for recording a small audio. The device comprising a housing, a pivotable lid attached to the housing using a pair of barrel hinges, the lid has one or more personalized enengravings for personalization, a non-functional and engraved play button, a non-functional, decorative, and engraved sound knob, a static stylus or arm to simulate the appearance of a record player, the free or pointed end of the stylus pointing to a decorative or symbolic vinyl record, a microphone for capturing audio input from a user, and storing it in an internal memory of the device, and a record button for activating the microphone for capturing and recording audio, wherein the device records audio up to a predetermined time duration such as four minutes, wherein the audio input post the predetermined time duration is not recorded.

In this manner, the personalized mini record player device of the present invention accomplishes all of the forgoing objectives and provides users with an audio recording device configured like a miniature record player enabling users to record custom audio for up to predetermined time period, for example 4-minutes. The recorded audio can be played back and thus provides a recipient with a sentimental message from an individual as a gift.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a personalized mini record player device designed as an audio recording device for recording a small audio. The device comprising a housing, a pivotable lid attached to the housing using a pair of barrel hinges, a non-functional and engraved play button, a non-functional, decorative, and engraved sound knob, a static stylus or arm to simulate the appearance of a record player, the free or pointed end of the stylus pointing to a decorative or symbolic vinyl record, a microphone for capturing audio input from a user, and storing it in an internal memory of the device, and a record button for activating the microphone for capturing and recording audio, wherein the device records audio up to a predetermined time duration.

In yet another embodiment, a record player device is disclosed. The record player device is used for recording an audio and includes a circuit board, a plurality of Li-Ion batteries, an internal memory connected to a speaker for storing and playing out recorded audio, a sound recorder module connected to a microphone for capturing user audio, a microprocessor to handle audio compression, filtering, and optimization to ensure clear recorded sound quality, wherein the speaker plays out the audio when a lid of the device is opened wherein the lid is pivotally coupled to a housing.

In another aspect of the present invention, a method for recording and playing audio on a record player device is described. The method comprising the steps of providing the record player device, pressing a record button, triggering the playback of a short audible alert to indicate the start of the recording process, capturing audio input from a user using a built-in sound module after the audible alert, playing the recorded audio for rechecking and calibration after the user finishes recording the desired audio, wherein the recording automatically stops upon reaching a predetermined duration, determining if the record button is clicked or pressed again, upon determining when the record button is clicked or pressed, storing the recorded sound in the internal memory of the device for playout and when the record button is not clicked or pressed, enabling the user to re-record the audio.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a personalized mini record player device of the present invention in accordance with the disclosed structure;

FIG. 2 illustrates a perspective view of the electronic devices included in the housing of the personalized mini record player device of the present invention in accordance with the disclosed structure;

FIG. 3 illustrates a top perspective view of the lid of the personalized mini record player device of the present invention in accordance with the disclosed structure;

FIG. 4 illustrates a flow chart depicting a process of recording an audio by the personalized mini record player device of the present invention in accordance with the disclosed structure; and

FIG. 5 illustrates a flow chart depicting use of the predetermined time period for recording audio in the record player device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a personalized and customized gift for loved ones. There is also a long felt need in the art for a personalized gift that adds sentimental value and personal touch in the gifting process. Additionally, there is a long felt need in the art for a gifting device that allows an individual to record a personalized message for a recipient. Moreover, there is a long felt need in the art for an audio recording device that can be given as a small gift to others for special occasions like a birthday, holiday, or anniversary. Further, there is a long felt need in the art for a personalized and customized gift that can be configured like a miniature record player. Furthermore, there is a long felt need in the art for a mini record player gift device that allows recipient of the gift to listen to a recorded customized audio from sender of the gift device. Finally, there is a long felt need in the art for a record player gift device that offers a much more sentimental and memorable gift compared to flowers, cards, and the like.

The present invention, in one exemplary embodiment, is a method for recording and playing audio on a record player device. The method comprising the steps of providing the record player device, pressing a record button, triggering the playback of a short audible alert to indicate the start of the recording process, capturing audio input from a user using a built-in sound module after the audible alert, playing the recorded audio for rechecking and calibration after the user finishes recording the desired audio, wherein the recording automatically stops upon reaching a predetermined duration, determining if the record button is clicked or pressed again, upon determining when the record button is clicked or pressed, storing the recorded sound in the internal memory of the device for playout and when the record button is not clicked or pressed, enabling the user to re-record the audio.

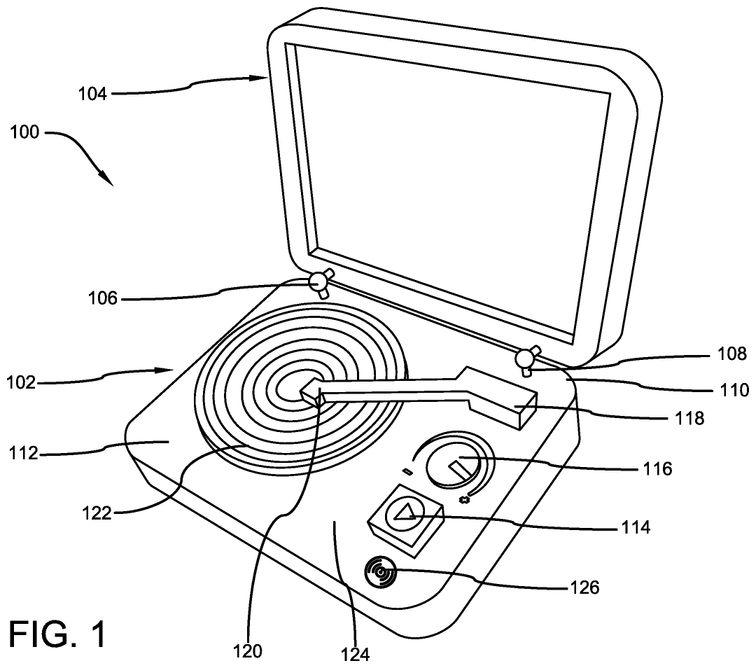

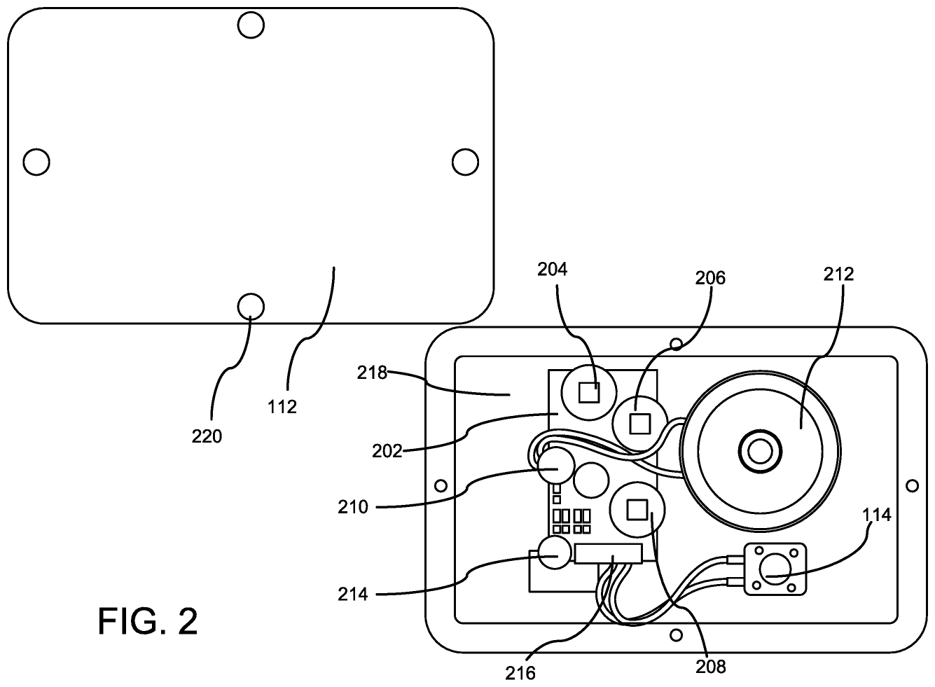

Referring initially to the drawings, FIG. 1 illustrates a perspective view of one potential embodiment of personalized mini record player device of the present invention in accordance with the disclosed structure. The personalized mini record player device 100 of the present invention is designed as an audio recording device for recording a small audio. The record player device 100 is preferably used for gifting and includes a recorded personalized message for providing sentimental value. The recorded audio or message can be a sentimental message, a favorite song, a personalized greeting, or any other audio that holds meaning for the gift recipient. More specifically, the record player 100 includes a housing 102 and a pivotable lid 104. The lid 104 is pivotally movable relative to the housing 102 using a pair of barrel hinges 106, 108. The hinges 106, 108 are positioned along the edge 110 of the housing 102 and allow the lid 104 to open and close smoothly without compromising the visual charm of the device 100. The barrel hinges 106, 108 can be one of straight barrel hinges, knuckled barrel hinges, and free-swinging barrel hinges. The housing 102 stores a plurality of electronic components for working of the device 100 as illustrated in FIG. 2.

The top surface 112 of the housing 102 includes a touch-based or physical play button 114 which can be activated for playing a recorded audio. The device 100 is used for recording and playing an audio message of up to a predetermined time duration such as 1 minute, 2 minutes, 4 minutes, 6 minutes, and the like. In some embodiments, the play button 114 can be engraved and non-functional and the audio can be played out automatically when the lid 104 is opened.

A non-functional, decorative, and engraved sound knob 116 is included to add to the nostalgic appearance of the device 100. In some embodiments, the sound knob 116 can be functional and can be used to adjust the volume of the sound played by the device 100.

A static stylus or arm 118 is glued to the top surface 112 of the housing 102 for providing look of a record player and the free or pointed end 120 of the stylus 118 points to a vinyl record 122. The vinyl record 122 is a decorative or symbolic representation of a vinyl record and adds to the conventional appearance of the device 100. For recording audio, a microphone 124 which can be a directional and echo cancellation microphone is integrated on the top surface 112. The microphone 124 captures the audio from a user and stores it in an internal memory of the device 100.

For recording an audio, a record button 126 is disposed in the housing 102 and can be on the top surface 112 or at any other appropriate position in the device 100. The record button 126 activates the microphone 124 for capturing and recording the audio and storing same internally in the device 100 as described in FIG. 2.

The record player gift device 100 is portable and compact and can be generally square or rectangular but can be of any geometric shape. In the present embodiment, the device 100 has dimensions of 6″ (L)×5″ (W)×1.5″ (H). The device 100 can be made of wood, metal, plastic, polymer, or any other waterproof and durable material. The lid 104 is designed to overlap the top surface 112 of the housing 102 to protect the components disposed on the top surface 112 of the housing 102 from debris, weather elements, and more.

FIG. 2 illustrates a perspective view of the electronic devices included in the housing of the personalized mini record player device of the present invention in accordance with the disclosed structure. The record player device 100 includes a plurality of electronic devices mounted on a circuit board 202 for providing functionality of recording and playing audio. As illustrated, a plurality of batteries 204, 206, 208 are mounted on the circuit board 202 for providing electric charge for functioning of the electronic components. The batteries 204, 206, 208 can be Li-Ion batteries and can work together for providing power to the electronic devices.

An internal memory 210 is connected to the speaker 212 for enabling the speaker 212 to playout the stored recorded audio in the internal memory 210. The internal memory 210 is designed to store a single audio for up to a predetermined duration. A sound recorder module 214 is connected to the microphone 124 for capturing audio of a user and converting same into machine-readable storage content for storage in the internal memory 210.

The play button 114 is connected to a microprocessor 216 of the device 100 for playing out the recorded audio from the speaker 212. The microprocessor 216 is also configured to control other components such as speaker 212 and microphone 124 of the device 100. The microprocessor 216 can handle audio compression, filtering, and optimization to ensure the recorded sound quality is clear. In some embodiments, the microprocessor 216 may be programmed to manage the recording time dynamically. This allows for greater flexibility in adjusting the recording duration of the record player device 100.

The electronic components are stored inside the housing 102 between the top surface 112 and the bottom surface 218 thereof. The top surface 112 and the bottom surface 218 are fastened using mechanical fasteners such as screws in the screwing holes 220 and can be detached for accessing the circuit board 202 which provides the electrical connections for functioning of the record player device 100.

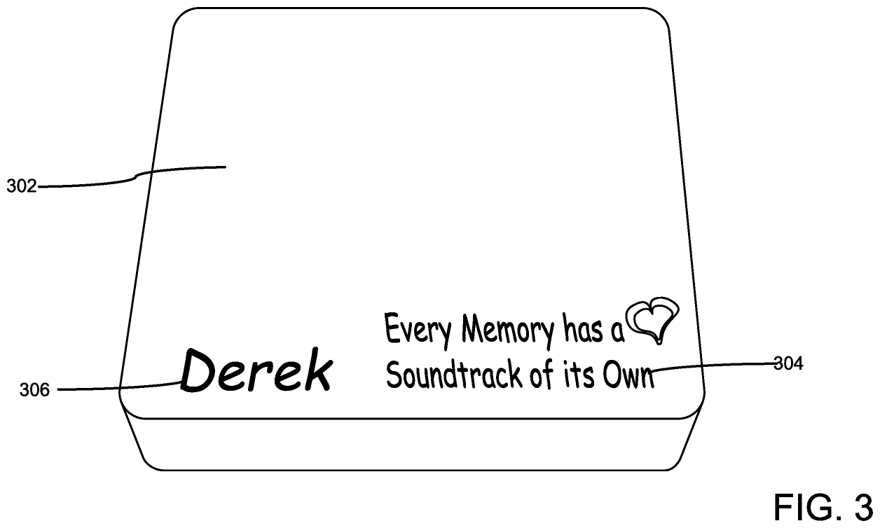

FIG. 3 illustrates a top perspective view of the lid of the personalized mini record player device of the present invention in accordance with the disclosed structure. The top surface 302 of the lid 104 has a customized engraving 304 for aesthetics purposes. Also, a personalized name 306 can be detachably embossed on the top surface 302, converting the device 100 into a personalized gift.

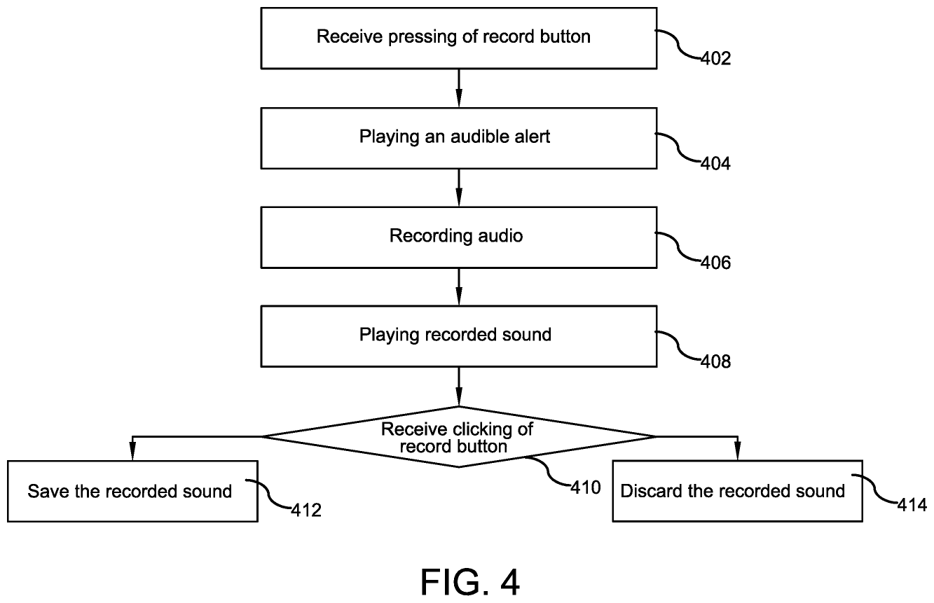

FIG. 4 illustrates a flow chart depicting a process of recording an audio by the personalized mini record player device of the present invention in accordance with the disclosed structure. Initially, the record button is pressed by a user, to activate the microphone for recording (Step 402). The record button is also coupled to the microprocessor for activating the microphone. Upon receiving the pressing of the record button, the microprocessor triggers the playback of a short audible alert (Step 404). The alert can be in the form of a brief sound or a chime, indicating to the user that the recording process has started.

After the audible alert, the device 100 starts recording audio. The built-in sound module 214 begins capturing the audio input from the user (Step 406). Once the user finishes recording the desired audio, the device 100 plays the recorded audio for rechecking and calibration (Step 408). It should be noted that the device 100 can record audio of a predetermined duration and the recording automatically stops upon reaching the maximum time limit.

Then, determination of clicking or pressing of the record button is determined (Step 410). In situations where the record button is pressed, then, the recorded sound is stored in the internal memory of the device for playout (Step 412). In situations where the record button is not pressed by the user, then the recorded sound is not stored. The record button can be initiated an additional time for recording again a message by the user and thereby discarding the first or original message (Step 414).

In some of the embodiments, the record button may be used for erasing the stored audio such by pressing the record button three times or four times consecutively within two seconds.

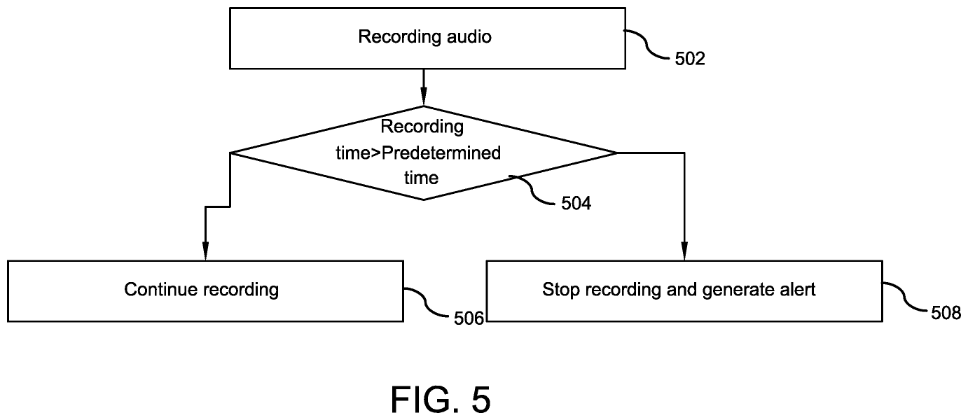

FIG. 5 illustrates a flow chart depicting use of the predetermined time period for recording audio in the record player device of the present invention in accordance with the disclosed structure. Initially, an audio from a user is recorded in the device (Step 502). While recording, a real-time recording time is measured by the microprocessor 216 for audio recording and is compared to the predetermined/preconfigured time for which the audio can be recorded and stored in the device (Step 504). In situations where the recording time is less than the predetermined time period, then, the recording is continued (Step 506), otherwise the recording is automatically stopped and an alert (a different alert from the alert described in FIG. 4) is generated for notifying the user about stopping of the recording (Step 508). As described earlier, in some embodiments, the predetermined time is fixed and alternatively, can be configurable to meet requirements of different users.

The recorded audio stored in the device can be of any type of audio and is played using the play button when the play button is functional. In some cases, when the play button is engraved and non-functional, then, the audio is automatically played when the lid 104 is opened and forms at least a 90-degree angle with the housing 104.

It will be apparent to a person having skill in the art that the DIY personalized mini record player device 100 allows a user to record a personalized message, song or any other audio for a recipient and can be given as a memorable and personalized gift. Recording an audio is easy and the device 100 is compact, portable, and cost-effective. Further, for music-lovers, the device 100 provides the nostalgic feeling of a record player.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “DIY personalized mini record player device”, “personalized mini record player device”, “record player device”, “record player”, and “device” are interchangeable and refer to the personalized mini record player device 100 of the present invention.

Notwithstanding the forgoing, the personalized mini record player device 100 of the present invention can be of any suitable size and configuration as is known in the art without affecting the overall concept of the invention, provided that it accomplishes the above stated objectives. One of ordinary skill in the art will appreciate that the personalized mini record player device 100 as shown in the FIGS. 1-3 are for illustrative purposes only, and that many other sizes and shapes of the personalized mini record player device 100 are well within the scope of the present disclosure. Although the dimensions of the personalized mini record player device 100 are important design parameters for user convenience, the personalized mini record player device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personalized audio recording and playing device comprising:
an audio recording device having a housing, a pivotable lid, and a plurality of electronic components for recording and playing an audio message;
wherein said electronic components having a touch based record button and a play button for initiating an audio recording and actuating a playback of said audio recording, a volume adjustment, a speaker, a microphone, a memory, and a microprocessor;
wherein said record button activates said microphone for capturing said audio recording and for saving said audio recording to said memory; and
further wherein said audio recording having a message duration of up to a predetermined time duration.

2. The personalized audio recording and playing device of claim 1, wherein said predetermined time duration is selected from the group consisting of 1 minute, 2 minutes, 4 minutes, and 6 minutes.

3. The personalized audio recording and playing device of claim 2, wherein said playback of said audio recording automatically actuated upon opening said lid.

4. The personalized audio recording and playing device of claim 3, wherein said electronic components having a power supply including batteries for portability of said audio recording device.

5. The personalized audio recording and playing device of claim 4, wherein said memory connected to said speaker for said playback of said audio recording.

6. The personalized audio recording and playing device of claim 5, wherein said audio recording is a single audio message.

7. The personalized audio recording and playing device of claim 6, wherein said microprocessor controlling said speaker and said microphone during said recording and said playback of said audio recording.

8. The personalized audio recording and playing device of claim 7, wherein said microprocessor controlling an audio compression, an audio filtering, and an audio optimization of said audio recording.

9. A personalized audio recording and playing device comprising:
an audio recording device having a housing, a pivotable lid, and a plurality of electronic components for recording and playing an audio message;
wherein said electronic components having a touch based record button and a play button for initiating an audio recording and actuating a playback of said audio recording, a volume adjustment, a speaker, a microphone, a memory, and a microprocessor;
wherein said record button activates said microphone for capturing said audio recording and for saving said audio recording to said memory;
wherein said audio recording having a message duration of up to a predetermined time duration;
wherein said memory connected to said speaker for said playback of said audio recording; and
further wherein said audio recording is a single personalized audio message.

10. The personalized audio recording and playing device of claim 9, wherein said predetermined time duration is selected from the group consisting of 1 minute, 2 minutes, 4 minutes, and 6 minutes.

11. The personalized audio recording and playing device of claim 10, wherein said playback of said audio recording automatically actuated upon opening said lid.

12. The personalized audio recording and playing device of claim 11, wherein said electronic components having a power supply including batteries for portability of said audio recording device.

13. The personalized audio recording and playing device of claim 12, wherein said microprocessor controlling said speaker and said microphone during said recording and said playback of said audio recording.

14. The personalized audio recording and playing device of claim 13, wherein said microprocessor controlling an audio compression, an audio filtering, and an audio optimization of said audio recording.

15. A method of personalizing an audio recording, the method comprising the steps of:
providing an audio recording device having a housing, a pivotable lid, and a plurality of electronic components for recording and playing an audio message, wherein said electronic components having a touch based record button and a play button for initiating an audio recording and actuating a playback of said audio recording, a volume adjustment, a speaker, a microphone, a memory, and a microprocessor;
actuating said record button for activating said microphone for capturing said audio recording;
alerting a user of said audio recording device with an audible alert, wherein said audible alert indicating to the user that said audio recording has started;
saving said audio recording to said memory, wherein said audio recording having a message duration of up to a predetermined time duration; and
connecting said memory to said speaker for said playback of said audio recording, wherein said audio recording is a single personalized audio message.

16. The method of personalizing an audio recording of claim 15, wherein said predetermined time duration is selected from the group consisting of 1 minute, 2 minutes, 4 minutes, and 6 minutes.

17. The method of personalizing an audio recording of claim 16, wherein said playback of said audio recording automatically actuated upon opening said lid.

18. The method of personalizing an audio recording of claim 17, wherein said electronic components having a power supply including batteries for portability of said audio recording device.

19. The method of personalizing an audio recording of claim 18, wherein said microprocessor controlling said speaker and said microphone during said recording and said playback of said audio recording.

20. The method of personalizing an audio recording of claim 19, wherein said microprocessor controlling an audio compression, an audio filtering, and an audio optimization of said audio recording.
